(19) United States
(12) Patent Application Publication
(10) Pub. No.: US 2012/0047543 A1
(43) Pub. Date: Feb. 23, 2012

(54) COMMUNICATION DEVICE AND METHOD FOR ESTABLISHING VIDEO COMMUNICATION

(75) Inventors: CHUNG-HSUAN KUO, Tu-Cheng (TW); MING-CHOU CHIANG, Tu-Cheng (TW); CHUN HSU, Tu-Cheng (TW); JIN-HAU KUO, Tu-Cheng (TW); JIN-HUE LIN, Tu-Cheng (TW)

(73) Assignee: HON HAI PRECISION INDUSTRY CO., LTD., Tu-Cheng (TW)

(21) Appl. No.: 12/901,558

(22) Filed: Oct. 10, 2010

(30) Foreign Application Priority Data
Aug. 17, 2010 (CN) 201010255366.5

(51) Int. Cl. H04N 7/173

(52) U.S. Cl. 725/106

(57) ABSTRACT

A method for establishing a video communication using a communication device includes sending local audio signals to the remote communication device, receiving response audio signals from the remote communication device. The method further includes controlling the local UPnP set-top box to send local video signals to the remote UPnP set-top box according to the IP address of the remote UPnP set-top box, controlling the local UPnP set-top box to receive response video signals from the remote UPnP set-top box.

### BACKGROUND

1. Field of the disclosure

Embodiments of the present disclosure relate to video communication, and more particularly to a communication device and a method for establishing a video communication using the communication device.

2. Description of Related Art

Generally, a videophone transmits both video signals and audio signals through telephone lines. The telephone lines may be unshielded twisted pair (UTP), which is mainly used to transmit audio signals. If the UTP is used to transmit both of the video signals and audio signals, a transmission rate of the video signals and audio signals would be influenced. For example, the transmission rate may be decreased, such as 33.6 k. Thus, unclear and incoherent images will be displayed on the videophone if both of the video signals and the audio signals are transmitted through the telephone lines.

### BRIEF DESCRIPTION OF THE DRAWINGS

FIG. 1 is a block diagram of one embodiment of a local communication device.

FIG. 2 is a flowchart of one embodiment of a method for establishing a video communication using a communication device, such as, that of FIG. 1.

### DETAILED DESCRIPTION

All of the processes described may be embodied in, and fully automated by, functional code modules executed by one or more general purpose computers or processors. The code modules may be stored in any type of computer-readable medium or other computer storage device. Some or all of the methods may alternatively be embodied in specialized computer hardware.

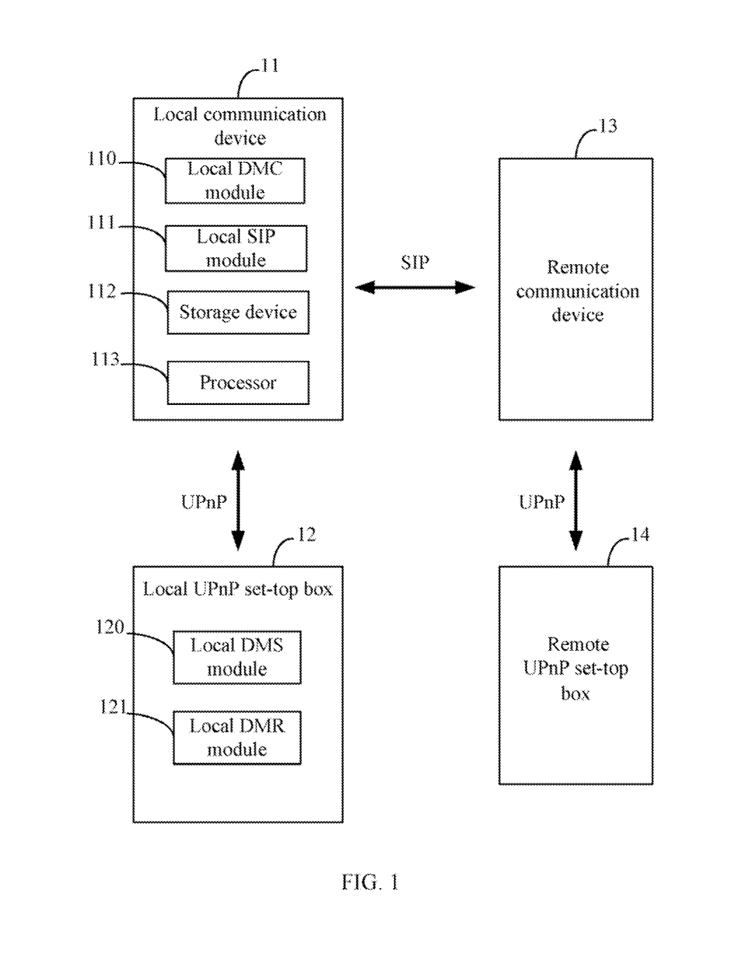

FIG. 1 is a block diagram of one embodiment of a local communication device 11. The local communication device 11 may communicate with a local universal plug and play (UPnP) set-top box 12 through an UPnP protocol, and communicate with a remote communication device 13 through a session initiation protocol (SIP). The remote communication device 13 may communicate with a remote UPnP set-top box 14 through the UPnP protocol. The local communication device 11 may control the local

UPnP set-top box 12 to send and receive video signals to obtain clear and coherent images. It should be understood that UPnP is a set of networking protocols for primarily residential networks without expert administrators. UPnP permits networked devices, such as personal computers, printers, Internet gateways, WIFI access points, and mobile device, to seamlessly discover each others presence on the network and establish functional network services for data sharing, communications, and entertainment.

The local communication device 11 includes a storage device 112 and a processor 113. The storage device 112 stores one or more programs, such as operating systems, other applications of the local communication device 11, and various kinds of data. In one embodiment, the storage device 112 may be a memory of the local communication device 11 or an external storage card, such as a memory stick, a subscriber identification module (SIM) card, a smart media card, a compact flash card, or any other type of memory card.

In one embodiment, the local communication device 11 may further include a local digital media controller (DMC) module 110 and a local SIP module 111. The local UPnP set-top box includes a local digital media server (DMS) module 120 and a local digital media renderer (DMR) module 121. The modules 110 and 111 may comprise computerized code in the form of one or more programs that are stored in the storage device 112 (or memory). The computerized code includes instructions that are executed by the at least one processor 113 to provide functions for modules 110 and 111.

The local DMC module 110 searches for the local UPnP set-top box 12 using a simple service discovery protocol in a network. If there is the local UPnP set-top box 12 in the network, the local DMC module 110 obtains an Internet Protocol (IP) address of the local UPnP set-top box 12 from the network. The network may be a digital living network alliance (DLNA). The UPnP set-top box 12 is a “plug-and-play” device when connected to the network, and automatically establishes working configurations with other devices, such as a name of the local UPnP set-top box 12, a serial number of the local UPnP set-top box 12, a name of a manufacturing company that produced the local UPnP set-top box 12, and functions of the local UPnP set-top box 12. In one embodiment, the working configurations are stored in an extensible markup language (XML) file of the network. The local DMC module 110 determines there is a local UPnP set-top box 12 in the network if the XML file includes working configurations of the local UPnP set-top box 12.

The local SIP module 111 sends the IP address of the local UPnP set-top box 12 and a request for obtaining an IP address of the remote UPnP set-top box 14 to the remote communication device 13. The remote communication device 13 receives the IP address of the local UPnP set-top box 12 and the request for obtaining the IP address of the remote UPnP set-top box 14, and sends the received IP address of the local UPnP set-top box 12 to the remote UPnP set-top box 14. The remote communication device 13 further obtains the IP address of the remote UPnP set-top box 14, and sends the IP address of the remote UPnP set-top box 14 to the local SIP module 111.

The local SIP module 111 receives the IP address of the remote UPnP set-top box 14 from the remote communication device 13.

The local DMC module 110 sends the IP address of the remote UPnP set-top box 14 to the local UPnP set-top box 12 according to a “SetURI” instruction of a UPnP audio and video (AV) Architecture protocol.

The local SIP module 111 sends local audio signals to the remote communication device 13 according to an SIP.

The local SIP module 111 receives response audio signals from the remote communication device 13 according to the SIP.

The local DMC module 110 sends a “record” instruction of the UPnP AV

Architecture to the DMR 121 of the local UPnP set-top box 12, to control the DMR 121 to send local video signals to the remote UPnP set-top box 14 according to the IP address of the remote UPnP set-top box 14 through a real time streaming protocol (RTSP).

The local DMC module 110 controls the DMS 120 of the local UPnP set-top box 12 to receive response video signals from the remote UPnP set-top box 14 through the RSTP.

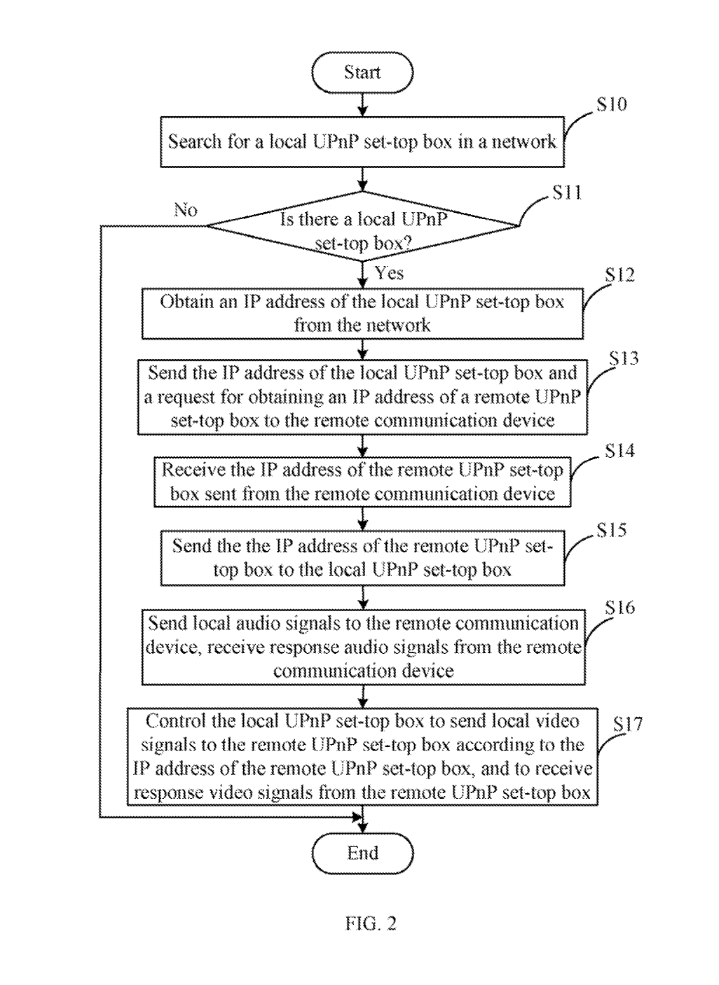

FIG. 2 is a flowchart of one embodiment of a method for establishing a video communication using a communication device 11. Depending on the embodiment, additional blocks may be added, others removed, and the ordering of the steps may be changed.

In block S10, the local DMC module 110 searches for the local UPnP set-top box 12 using a simple service discovery protocol in a network.

In block S11, the local SIP module 111 determines whether there is a local UPnP set-top box 12 in the network.

In block S12, the local DMC module 110 obtains an IP address of the local UPnP set-top box 12 from the network if there is the local UPnP set-top box 12 in the network.

In block S13, the local SIP module 111 sends the IP address of the local UPnP set-top box 12 and a request for obtaining an IP address of the remote UPnP set-top box 14 to the remote communication device 13. The remote communication device 13 receives the IP address of the local UPnP set-top box 12 and a request for obtaining an IP address of the remote UPnP set-top box 14, sends the received IP address of the local UPnP set-top box 12 to the remote UPnP set-top box 14, obtains the IP address of the remote UPnP set-top box 14, and sends the IP address of the remote UPnP set-top box 14 to the local SIP module 111.

In block S14, the local SIP module 111 receives the IP address of the remote UPnP set-top box 14 from the remote communication device 13.

In block S15, the local DMC module 110 sends the IP address of the remote UPnP set-top box 14 to the local UPnP set-top box 12 according to a “SetURI” instruction of a UPnP AV Architecture protocol.

In block S16, the local SIP module 111 sends local audio signals to the remote communication device 13 according to the SIP, and receives response audio signals from the remote communication device 13 according to an SIP.

In block S17, the local DMC module 110 sends a “record” instruction of the UPnP AV Architecture to the DMR 121, to control the DMR 121 to send local video signals to the remote UPnP set-top box 14 according to the IP address of the remote UPnP set-top box 14 through the RTSP, and controls the DMS 120 of the local UPnP set-top box 12 to receive response video signals from the remote UPnP set-top box 14 according to the RTSP.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A communication device, the communication device in communication with a remote communication device and a local universal plug and play (UPnP) set-top box, the remote communication device in communication with a remote UPnP set-top box, the communication device comprising:
a storage device;
at least one processor; and
one or more programs stored in the storage device and being executable by the at least one processor, the one or more programs comprising a local digital media controller (DMC) module and a local session initiation protocol (SIP) module:
the local DMC module being operable to obtain an Internet Protocol (IP) address of the local UPnP set-top box;
the local SIP module being operable to send the IP address of the local UPnP set-top box and a request for obtaining an IP address of the remote UPnP set-top box to the remote communication device, and receive the IP address of the remote UPnP set-top box from the remote communication device;
the local DMC module being further operable to send the IP address of the remote UPnP set-top box to the local UPnP set-top box;
the local SIP module being further operable to send local audio signals to the remote communication device, and receive response audio signals from the remote communication device; and
the local DMC module being further operable to control the local UPnP set-top box to send local video signals to the remote UPnP set-top box according to the IP address of the remote UPnP set-top box, and control the local UPnP set-top box to receive response video signals from the remote UPnP set-top box.

2. The communication device of claim 1, wherein the local DMC module is further operable to search a network for the local UPnP set-top box according to a simple service discovery protocol.

3. The communication device of claim 1, wherein the SIP module sends the local audio signals to the remote communication device according to a session initiation protocol.

4. The communication device of claim 1, wherein the local DMC module sends the IP address of the remote UPnP set-top box to a digital media renderer (DMR) of the local UPnP set-top box according to a “SetURI” instruction of a UPnP audio and video (AV) Architecture.

5. The communication device of claim 4, wherein the local DMC module controls the DMR to send the local video signals to the remote UPnP set-top box according to a real time streaming protocol by sending a “record” instruction of the UPnP AV Architecture to the DMR, and controls a digital media server (DMS) to receive the response video signals from the remote UPnP set-top box according to the real time streaming protocol.

6. A method for establishing a video communication using a communication device, the method comprising:
obtaining an Internet Protocol (IP) address of the local UPnP set-top box from the network;
sending the IP address of the local UPnP set-top box and a request for obtaining an IP address of a remote UPnP set-top box to a remote communication device;
receiving the IP address of the remote UPnP set-top box from the remote communication device;
sending the IP address of the remote UPnP set-top box to the local UPnP set-top box;
sending local audio signals to the remote communication device;
receiving response audio signals from the remote communication device;
controlling the local UPnP set-top box to send local video signals to the remote UPnP set-top box according to the IP address of the remote UPnP set-top box; and
controlling the local UPnP set-top box to receive response video signals from the remote UPnP set-top box.

7. The method of claim 6, wherein the step of searching a network for the local UPnP set-top box according to a simple service discovery protocol.

8. The method of claim 6, wherein the step of sending audio signals to the remote communication device according to a session initiation protocol.

9. The method of claim 6, wherein the step of sending the IP address of the remote UPnP set-top box to a digital media renderer (DMR) of the local UPnP set-top box according to a “SetURI” instruction of a UPnP audio and video (AV) Architecture.

10. The method of claim 9, wherein the step of controlling the DMR to send the local video signals to the remote UPnP set-top box according to a real time streaming protocol by sending a “record” instruction of the UPnP AV Architecture to the DMR, and controlling a digital media server (DMS) to receive the response video signals from the remote UPnP set-top box according to the real time streaming protocol.

11. A storage medium having stored thereon instructions that, when executed by a processor, cause the processor to perform a method for establishing a video communication using a communication device, the method comprising:
obtaining an Internet Protocol (IP) address of the local UPnP set-top box from the network;
sending the IP address of the local UPnP set-top box and a request for obtaining an IP address of a remote UPnP set-top box to a remote communication device;
receiving the IP address of the remote UPnP set-top box from the remote communication device;
sending the IP address of the remote UPnP set-top box to the local UPnP set-top box;
sending local audio signals to the remote communication device;
receiving response audio signals from the remote communication device;
controlling the local UPnP set-top box to send local video signals to the remote UPnP set-top box according to the IP address of the remote UPnP set-top box; and
controlling the local UPnP set-top box to receive response video signals from the remote UPnP set-top box.

12. The medium of claim 11, wherein the step of searching a network for the local UPnP set-top box according to a simple service discovery protocol.

13. The medium of claim 11, wherein the step of sending audio signals to the remote communication device according to a session initiation protocol.

14. The medium of claim 11, wherein the step of sending the IP address of the remote UPnP set-top box to a digital media renderer (DMR) of the local UPnP set-top box according to a “SetURI” instruction of a UPnP audio and video (AV) Architecture.

15. The method of claim 14, wherein the step of controlling the DMR to send the local video signals to the remote UPnP set-top box according to a real time streaming protocol by sending a “record” instruction of the UPnP AV Architecture to the DMR, and controlling a digital media server (DMS) to receive the response video signals from the remote UPnP set-top box according to the real time streaming protocol.
